(19) United States
(12) Patent Application Publication
(10) Pub. No.: US 2004/0151489 A1
(43) Pub. Date: Aug. 5, 2004

(54) Imaging system for producing double exposure composite images and application thereof

(76) Inventor: Xianfeng Zhou, Beijing (CN)

Correspondence Address: Raymond Yat Chan, Suite 128, 108 North Ynez Avenue, Monterey Park, CA, 91754, US

(21) Appl. No.: 10/471,937

(22) PCT Filed: Mar. 15, 2002
(86) PCT No.: PCT/CN02/00163

(30) Foreign Application Priority Data
Mar. 16, 2001 (CN) 01103873.X
Mar. 14, 2002 (CN) 02104433.3

(51) Int. Cl. G03B 41/00

(52) U.S. Cl. 396/322

(57) ABSTRACT

The invention discloses an imaging system for producing double exposure composite images and application method therefor. This system includes a cartridge-clip camera and a cartridge-clip film. The cartridge-clip camera can achieve a conversion between a full-frame transmission and a half-frame transmission by a fixed-frame wheel, and can also provide a single-sheet-film card. The film may be a kind of information medium, on which there are various pre-exposed picture-and-word information latent images. When the cartridge-clip camera uses the cartridge-clip film, it can employ a positioning means for locating to make the cartridge clip provided with the film to be conveniently and accurately located in the cartridge-clip camera, and can produce accurately located double exposure composite images, thereby overcoming the drawback of known art, using conveniently and avoiding waste. In the use of the imaging system, the invention can independent package and sale the film,

### FIELD OF THE INVENTION

The present invention is related to an imaging system and application thereof, in particular an image system for producing double-exposure composite images and its application method.

### BACKGROUND OF THE INVENTION

With the development of new technologies, different kinds of cameras have appeared in the camera industry. Legacy cameras can only use with specific monochrome films or color films; however, people expect to achieve image composition on films, for example, adding blessings on films. To attain the aim, the films has to be pre-exposed partially to carry picture-and-word latent images, then they may be used on common cameras. However, that approach is difficult to implement due to the shielding system and film-loading pattern of legacy cameras. For example, in the camera described in US patent “Film with Pre-Exposed Images and Shielding system”, the shielding system has to be set manually to avoid the impact of re-exposure. That shielding system is poor in accuracy and difficult to implement, often resulting in dislocation between images created in the two exposure processes.

The technology disclosed in U.S. Pat. No. 5,615,396 “Producing Smoothly Blended Double Exposure Composite Images” is a known technology, which is mainly used to achieve smooth transition at the circumferences of double exposure composite images. However, that technology didn't solve the film positioning problem and isn't suitable for applying double exposure films in reusable cameras.

A type of film cassette containing pre-exposed film is disclosed in U.S. Pat. No. 5,187,512. In that patent, the inventor loads a pre-exposed film into a film cassette with a transparent window on the back. A protective layer with figures (“1”, “2”, . . . ) shall be applied on the back of said pre-exposed film. When said film cassette is loaded in a suitable camera, the operator may wind the film roller. When the FIG. “1” appears in the transparent window on the back of the camera, it indicates the current frame is the first frame of said pre-exposed film. Though that means supports reuse of pre-exposed films on said camera, however, the protective layer on the back of said pre-exposed film increase complexity and cost of production, and it is similar to “120#” films, which are obsolete now. Moreover, the increase of film thickness may confine the allowable length of that film in the film cassette. And because the film-winding action occurs at the same time of viewing the figure through the window during positioning the first frame, the positioning operation is relatively complex and may easily lead to dislocation of re-exposed images.

In addition, in a previous patent of the inventor—“a Method for Producing Ad Photographs” (Doc. No.: 97111788.8) and “Photographs & Ads Combined Camera” (Doc. No.: 00245349.5), a new camera is disclosed, which not only keeps latent images of images/texts immune to re-exposure and prevents image dislocation, but also achieve duplex color effects, i.e., different ad contents and images may coexist on any photograph. However, that cameras still has the following shortcomings: the problem of accurate positioning of film in the camera is still untouched, thus pre-exposed films still can't be sold as a commodity independently, instead, they have to be sold with discardable cameras, which can't be reused, therefore resulting in unnecessary waste.

In addition, most of the existing cameras usually require photographing and flushing on the basis of entire film roll, resulting in waste or inconvenience to some extent. As for existing discardable cameras or simple MINI cameras, due to their fixed apertures and shutters, only films of a specific photosensitivity may be used, often resulting in unsatisfying photographs. In the inventor's previous Chinese patent “a Method for Producing Ad Photographs” (Doc. No.: 97111788.8) and “Photographs & Ads Combined Camera” (Doc. No.: 00245349.5), the inventions are also not flexible enough, and films of different photosensitivities can't be used in the same cartridge-clip camera.

### OVERVIEW OF THE INVENTION

The purpose of the present invention is to provide an imaging system for producing double exposure composite images and its application method; said image system comprises a cartridge-clip camera and a cartridge-clip film; said film may be an information medium carrying pre-exposed picture-and-word latent images. Said cartridge-clip camera may position said cartridge clip with positioning means to embed said cartridge clip loaded with film conveniently and accurately in said cartridge-clip camera, in order to create accurately positioned double exposure composite images; said image system may overcame drawbacks in known art, improve convenience in application, and avoid waste. In application of said imaging system, films with pre-exposed latent images may be packed and sold separately; said films have 2 zones, an unexposed zone and an exposed zone; said exposed zone may serve as an information medium and contain picture-and-word information.

Another purpose of the present invention is to develop a single-sheet-film card and suited single-sheet-film clipping seat on the basis of existing technical features of cartridge-clip cameras, to enhance the flexibility and practicability of cartridge-clip cameras in adapting to different films; provide full frame/half frame switching function for images to further take advantage film space, enhancing economical efficiency and practicability of film application as well as flexibility of cameras and films in application; facilitate cartridge-clip cameras to adapt to films of different photo-sensitivities with aperture plates. The invention may ensure correct exposure of films in different environments and highlights outstanding cost-performance of cartridge-clip cameras.

Another purpose of the present invention is to provide a single-sheet-film card, which may be sold as independent commodity or gift and helps to change people's traditional film consumption habit and significant decrease the cost of film consumption. Particularly, the invention provides custom information composition function on the basis of pre-exposure of information films, further expanding the market scope of said single-sheet-film card as gift and ad commodity, to attain the purpose of extensive application of said single-sheet-film cards.

The purposes of the present invention are implemented as follows: a cartridge-clip camera for the image system for producing double exposure composite images, said camera comprises a camera body, a lens, and a counter, and:

a frame-fixing device, which may fix the start position of said film and regulate the breadth of film frame;

a cartridge clip, which may hold a film cassette; said frame-fixing device is mounted on said clipping seat;

an automatic resetting device connected to said frame-fixing device; when the film is attached to said frame-fixing device and the start position of it is determined, the position of the first frame of the film may be determined with the automatic resetting device; when the rear cover of the camera is opened, said automatic reset device will reset automatically to ensure the accurate positioning of the composite image after double exposure.

The cartridge-clip camera as above, wherein said camera body has a rear cover; when said rear cover is opened, said film may be loaded into said cartridge clip.

The cartridge-clip camera as above, wherein said cartridge clip is connected to a left chamber and a right chamber on its sides, respectively; said right chamber has a winding hand-wheel and a spindle nose on the top; said left chamber has a spur gear embedded in a groove on the top; said cartridge clip has a frame-fixing device mounted on it.

The cartridge-clip camera as above, wherein said cartridge clip has a positioning groove on it.

The cartridge-clip camera as above, wherein said frame-fixing device may be a fixed-frame wheel, which may protrudes out from the right-top part of said cartridge clip.

The cartridge-clip camera as above, wherein said camera body has a 180° unidirectional frame-fixing ratchet wheel and an adjusting pin mounted with a clipping seat dedicated for half-frame transmission; said dedicated clipping seat is set to use with a half-frame imaging frame.

The cartridge-clip camera as above, wherein a 360° unidirectional frame-fixing ratchet wheel is set as default, the original dedicated clipping seat is fixed on the cartridge clip in the chamber of said cartridge-clip camera, the film is transferred through said 360° unidirectional ratchet wheel, which locks the film at 35 mm interval in each rotation to implement full frame imaging; an additional 180° unidirectional frame-fixing ratchet is added and set to standby mode, when the clipping seat dedicated for half-frame transmission (with a half-frame imaging frame and an adjusting pin) is mounted on said camera, it alters the position of said frame-fixing ratchet wheel on said camera body, said clipping seat dedicated for half-frame transmission is also fixed on the cartridge clip in the chamber of said cartridge-clip camera, the film is transferred through said 180° unidirectional ratchet wheel, which locks the film at 16 mm interval in each cycle to implement half-frame imaging.

A cartridge-clip camera as above, wherein said camera body has a reciprocating aperture plate with pre-drilled apertures of different diameters; the clipping seat for different types of films has an adjusting pin, which will prod said aperture plate downwards when the clipping seat is loaded into the cartridge clip in said cartridge-clip camera.

A cartridge-clip camera as above, wherein said camera body has a reciprocating aperture plate passing through the adjusting pin on different types of film clipping seats; there are apertures of different diameters on said reciprocating aperture plate, when said reciprocating aperture plate is mounted in the chamber of said cartridge-clip camera, said apertures will correspond to different photosensitivity settings, thus the cartridge-clip camera may be used wit films of different photo-sensitivities. Through presetting the position of said adjusting pin, said cartridge-clip camera may distinguish photosensitivity of the film in a mechanical way.

The cartridge-clip camera as above, wherein said automatic resetting device comprises a gearing structure and an elastic resetting element.

The cartridge-clip camera as above, wherein said automatic resetting device comprises a pair of coupled gear/rack; said gear is connected to said fixed-frame wheel in axial direction; said elastic resetting element may be a draught spring connected to said camera body on one end and to a end of said rack on the other end; said rack has a lock hole that may be coupled with the lock pin on said rear cover on the other end.

The cartridge-clip camera as above, wherein said cartridge clip may contain a clipping seat.

The cartridge-clip camera as above, wherein said clipping seat may comprise an imaging frame and a bracket on the left; a winding shaft is hinged in said bracket and is fitted with a spur gear on its top; said imaging frame has a standard imaging aperture, a through-hole of fixed-frame wheel, and a positioning tab on its back.

The cartridge-clip camera as above, wherein said camera body has a film bank on one side.

A cartridge-clip camera for image system producing double exposure composite images, mainly comprising a single-sheet-film card and a suited clipping seat; wherein said single-sheet-film card is fixed in said clipping seat, which substitutes the chamber originally used for above cartridge-clip film and has a imaging frame on its front; said clipping seat may be coupled with the cartridge clip of said camera body; when they are coupled to each other, the length of projection plane in the chamber of said clipping seat is still equal to the focal length of said camera.

The cartridge-clip camera for image system for producing double exposure composite images as above, wherein said single-sheet-film card comprises: a card carrier, a sheet film, and a sealed shielding plate (for sheet film with pre-imposed picture-and-word information, an imaging frame may be applied); said sheet film is installed in the chamber of said card carrier; said card carrier has sliding grooves for said sealed shielding plate on its both end; there is a positioning tab corresponding to a film sprocket hole in the chamber of said card carrier; the photo-sensing membrane of said sheet film faces against said sealed shielding plate; said dedicated clipping seat contacts firmly with the inner wall of said imaging frame when it is mounted in said camera; there are positioning holes for chamber of said dedicated clipping seat at the cross edges of said card carrier.

The cartridge-clip camera for image system for producing double exposure composite images as above, wherein said dedicated single-sheet-film clipping seat has an imaging frame on its front side, a positioning pin for installation of single-sheet-film cards in it, and a sealed shielding plate on its back; wherein said imaging frame on the front of said single-sheet-film clipping seat is coupled with the cartridge clip of said camera body.

The cartridge-clip camera for image system producing double exposure composite images as above, wherein said film membrane of single-sheet-film card faces against said sealed shielding plate; when said single-sheet-film card is loaded in said dedicated clipping seat during said sealed shielding plate is in closed state, the positioning hole on said sheet film is coupled to the positioning pin on said dedicated clipping seat; when the sealed clipping seating plate of said dedicated clipping seat is closed and the sealed shielding plate is drawn out, the film contacts seamlessly with the imaging frame of said dedicated clipping seat, and said dedicated clipping seat in turn contacts seamlessly with the cartridge clip in said cartridge-clip camera; after the rear cover of said camera body is closed, photographing may be done to achieve a common sheet film with picture-and-word latent images; then, the sheet film with pre-exposed information may be loaded into said single-sheet-film card to create an information single-sheet-film card, which then are added with said imaging frames; the photo-sensing membrane of said information single-sheet-film card faces against said sealed shielding plate, which is in closed state; when said single-sheet-film card is loaded into the chamber of said dedicated clipping seat, the positioning hole of said single-sheet-film card is coupled with the positioning pin in said dedicated clipping seat; when the rear plate of said dedicated clipping seat is closed, the sealed shielding plate for said single-sheet-film card may be drawn out, and then said imaging frame contacts closely with the inner wall of said dedicate clipping seat, and said dedicate clipping seat is coupled with the cartridge clip in the chamber of said cartridge-clip camera; when the rear cover of said cartridge-clip camera is closed, photographing may be done for re-exposure in order to create composite images on said single-sheet-film card.

A kind of cartridge-clip film roll for imaging system producing double exposure composite images, wherein said cartridge-clip film roll comprises a cartridge clip, a cassette, a roll of film, and a casing.

The cartridge-clip film roll as above, wherein said cartridge clip has an imaging frame and a cassette bracket on its right side; said cassette bracket supports a cassette and a dark chamber on the left; said imaging frame has an imaging aperture, a through-hole of fixed-frame wheel, a film lock pin, and a positioning tab on its back.

The cartridge-clip film roll as above, wherein said imaging aperture may have a shielding part at an appropriate position.

The cartridge-clip film roll as above, wherein the film in said cartridge-clip film roll may be a film with picture-and-word information or an ordinary film.

The cartridge-clip film roll as above, wherein the casing of said cartridge-clip film roll may indicate the picture-and-word information and the information position of said film.

A positioning method for cartridge-clip film roll of the imaging system for producing double exposure composite images, said positioning method comprises the following procedures:

a. Form an unique installation sprocket hole on said film with picture-and-word information;

b. Load said film in the cassette and place the cassette in the cassette bracket on said cartridge clip to form a cartridge-clip film roll;

c. Load said cartridge-clip film roll in a suited cartridge-clip camera.

The positioning method for said cartridge-clip film roll as above, wherein said procedure “a” and procedure “b” mean: coincide unique installation sprocket hole on said film to the through-hole of fixed-frame wheel on the cartridge clip.

The positioning method for said cartridge-clip film roll as above, wherein said procedure “b” means: the shallow image/text shadow on each frame of said film faces against the imaging aperture on said cartridge clip and coincide to the shielding part of said imaging aperture.

The positioning method for said cartridge-clip film roll as above, wherein said procedure “c” means: when the cartridge-clip film roll is loaded into the cartridge-clip camera, the unique installation sprocket hole on said film and the through-hole of the fixed-frame wheel are hung together to the first tooth of said fixed-frame wheel, which has reset to its original position; when the rear cover of the camera is closed and the film is wound manually, each frame of picture-and-word latent image on said film will coincide to the lens of the camera; when the film is transferred, the rack of said automatic resetting device moves under the drive of said fixed-frame wheel and disengages from the gear, and then the lock pin on the rear cover will wedge into the lock hole on one side of said rack.

An application method for the imaging system for producing double exposure composite images, wherein the film of said cartridge-clip film roll has two zones: an unexposed zone and a exposed zone carrying picture-and-word information.

The application method as above, wherein the picture-and-word information in said exposed zone may be images of great ceremonies.

The application method as above, wherein the picture-and-word information in said exposed zone may be images of cartoons of children.

The application method as above, wherein the picture-and-word information in said exposed zone may be ad presentations.

The application method as above, wherein the picture-and-word information in said exposed zone may be scenery images of tourist spots.

The application method as above, wherein the picture-and-word information in said exposed zone may be image-planning content.

The application method as above, wherein the picture-and-word information in said exposed zone may be blessings or graphical images.

The application method as above, wherein the said exposed zone may be at any position in the frames of latent images and be composite with images created in re-exposure.

The application method as above, wherein said exposed zone contains ad picture-and-word information of different customers.

The application method as above, wherein said cartridge-clip film rolls may be sold independently.

The application method as above, wherein said cartridge-clip film rolls may be freely distributed to consumers as gifts for promotion.

The benefits of the present invention are: it overcomes shortcomings in traditional art, such as limited applicability of ordinary cameras to films, limitation in application of discardable cameras, etc.; it solve the relationship between the exposed latent images on film and the film transmission and frame-fixing on the camera, simplifies installation and application of film to camera, enhance the adaptability of cartridge-clip cameras to different types of films, and helps to align pre-exposed picture-and-word information with the content photographed subsequently to compose complete pictures; in that way, it helps to decrease cost for consumers and enrich people's life.

On the basis of original patent of a cartridge-clip camera, the invention provides a single-sheet-film card, which may be sold independently as a commodity: it expands the category of films applicable to cartridge-clip cameras, enriches image content, and embodies the marketability of the single-sheet-film card as gift, so that it expands the approach for sales promotion with those single-sheet-film cards. The design of cartridge-clip camera and dedicated half-frame clipping seat helps to increase the flexibility of film consumption and further promote the economical efficiency and practicability of films in application. Thus 135# films may also achieve the effect of 35 mm and 16 mm films. The aperture plate structure on the body of the cartridge-clip camera ensures that the camera is compatible to films of different photo-sensitivities and the film is exposed correctly, highlighting the outstanding cost-performance of the cartridge-clip camera and facilitate its popularization.

The imaging system producing double exposure composite images and the application of the imaging system described in the present invention makes films recording double exposure composite images a information medium, and provides a brand new “tangible and touchable” information dissemination medium-cartridge-clip film and camera in well known media including newspaper, TV, and network. The cartridge-clip film and camera, with pre-recorded rich and variable picture-and-word information, delivers media dissemination function while creates innovative, unique, and individualized images. The invention excavates a new application field for photographing facilities.

### BRIEF INSTRUCTION TO ATTACHED DRAWINGS

FIG. 1 is the front view of the cartridge-clip camera (recover removed) of the first embodiment implemented according to the present invention;

FIG. 2 is a partial sectional view of FIG. 1;

FIG. 3 is the front view of the cartridge-clip film in the present invention;

FIG. 4 is a sectional view of FIG. 3;

FIG. 5 is the front view of the dedicated clipping seat of the second embodiment implemented according to the present invention;

FIG. 6 is a sectional view of FIG. 5;

FIG. 7 is a structural sketch map of the automatic resetting device in the cartridge-clip camera in the present invention;

FIG. 8 is a sketch map of the single-sheet-film card in the present invention;

FIG. 9 is a sketch map of the dedicated clipping seat for the sheet film in the present invention;

FIG. 10 is a sketch map of the half-frame transmission structure in the present invention;

FIG. 10A is a sketch map of the full-frame transmission structure in the present invention;

FIG. 11 is a sketch map of the clipping seat with a half-frame imaging frame in the present invention;

FIG. 11A is a sketch map of the clipping seat with a standard imaging frame;

FIG. 12 is a sketch map of the aperture adjusting plate structure of the photosensitivity adjusting mechanism in the present invention;

FIG. 13 is a structural sketch map of the photosensitivity adjusting mechanism;

FIG. 14 is a sketch map of the cartridge clip with a photosensitivity adjusting mechanism in the present invention.

### DESCRIPTION OF PREFERRED EMBODIMENTS

Embodiment 1:

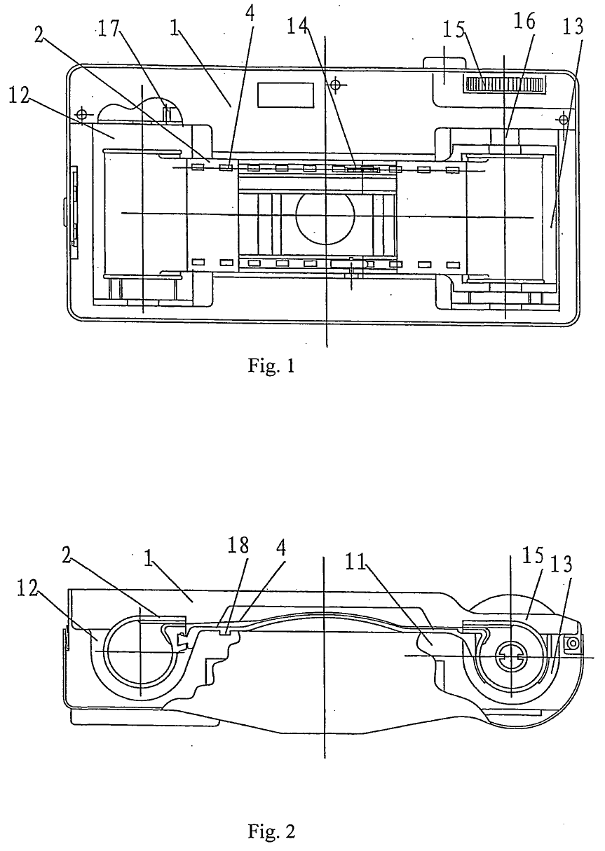

As shown in FIG. 1 and FIG. 2, the cartridge-clip camera for producing double exposure composite images provided in the present invention comprises a camera body (1), a lens, and a counter, and said camera may further comprises: a frame-fixing device used to positioning the starting position of the film and locking the frame; a cartridge clip (11), which may accommodate a cassette and said frame-fixing device; an automatic resetting device (3) coupled with said frame-fixing device, and when the film (4) is coupled to said frame-fixing device and the starting position of said film (4) is positioned, said automatic resetting device (3) may determine the position of the first frame of said film (4), when the rear cover of said camera is opened, said automatic resetting device (3) will reset automatically to ensure the correct alignment of composite images on said film (4) after re-exposure.

The structure of said cartridge-clip camera is: there is a rear cover on said camera body (1), when the rear cover is opened, a cartridge-clip film roll (2) may be loaded in said cartridge clip (11). Said cartridge clip (11) is connected to a left chamber (12) and a right chamber (13) on its sides, respectively; said right chamber (13) has a winding hand-wheel (15) and a spindle nose (16) on the top, said left chamber (12) has a spur gear (17) embedded in groove on the top, said cartridge clip (11) has a frame-fixing device and a positioning groove (18).

Said frame-fixing device may be a fixed-frame wheel (14), which may protrudes out from the right-top part of said cartridge clip.

As shown in FIG. 7, said automatic resetting device (3) comprises a gearing structure and an elastic resetting element. Said automatic resetting device (3) may include a pair of coupled gear (31)/rack (32); said gear (31) is connected to said fixed-frame wheel (14) in axial direction; said elastic resetting element may be a draught spring (33) connected to said camera body (1) on one end and to a end of said rack (32) on the other end; said rack (32) has a lock hole (34) that may be coupled with the lock pin (41) on said rear cover on the other end.

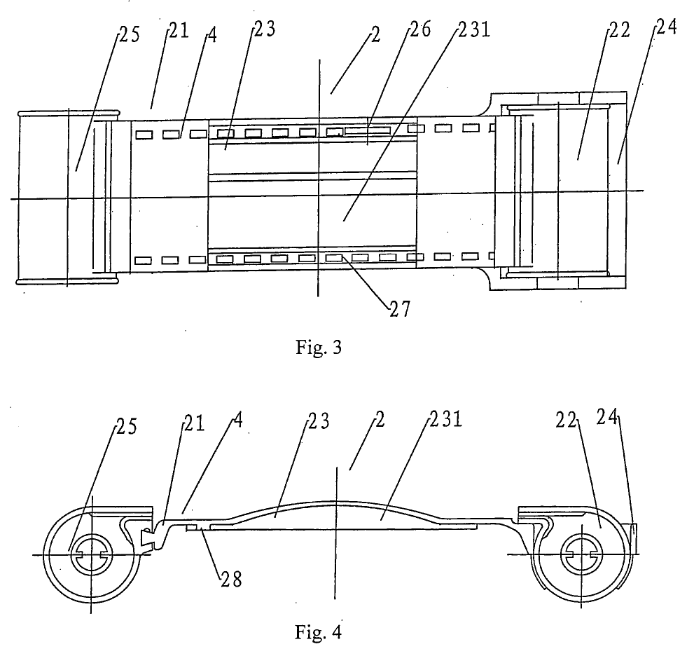

A cartridge-clip film roll (2) that may be used with said cartridge-clip camera, as shown in FIG. 3, wherein said cartridge-clip film roll (2) comprises a cartridge clip (21), a cassette (22), a film (4), and a casing. Said cartridge clip (21) has an imaging frame (23) and a cassette bracket (24) on its right side; said cassette bracket is connected to a dark chamber (25) on the left. Said imaging frame (23) has an imaging aperture (231), a through-hole (26) for fixed-frame wheel, a film lock pin (27), and a positioning tab (28) on its back.

Said imaging aperture (26) may have a shielding part at an appropriate position. Said cartridge-clip film roll (2) is created as follows: form a unique installation sprocket hole on said film (4) with picture-and-word information; load said film (4) in the cassette (22) and place the cassette (22) in the cassette bracket (24) on said cartridge clip (21) to form the cartridge-clip film roll (2).

Said unique installation sprocket hole on said film (4) with picture-and-word information in said cartridge-clip film roll (2) coincides with the through-hole (26) of the fixed-frame wheel on said cartridge clip (21), and each frame of said film (4) with pre-exposed picture-and-word information corresponds to the imaging aperture (231) on said cartridge clip (21) and coincides with the shielding part at appropriate position on said imaging aperture (231).

In application, open the rear cover of said cartridge-clip camera, the lock pin (41) disengages from the rack (32) of said automatic resetting device (3), and the rack (32) moves toward right under the drive of spring (33) (as shown in FIG. 7) and engages to the gear (31) and drives the gear (31) to rotate, at the same time, the rack (32) drives the fixed-frame wheel (14) to reset (i.e., returns to the first tooth); when the cartridge-clip film roll (2) is loaded into the cartridge-clip camera, the unique installation sprocket hole on said film and the through-hole (26) of the fixed-frame wheel on said cartridge clip (21) are hung together to the first tooth of said fixed-frame wheel (14), which has reset to its original position; when the rear cover of the camera is closed and the film (4) is wound manually, each frame with shallow image/text shadow on said film (4) will coincide to the lens of the camera; when the film is transmitted, the rack (32) of said automatic resetting device (3) moves under the drive of said fixed-frame wheel (14) and disengages from the gear (31), and then the lock pin (41) on the rear cover will wedge into the lock hole (34) on one side of said rack (32) to position the cartridge-clip film roll (2) to the cartridge-clip camera. When above process is finished, the length of projection plane in the chamber of said clipping seat is equal to the focal length of said camera after the cartridge clip (11) is coupled to the imaging frame (23) on the cartridge-clip film roll (2), and during film transmission, each frame of picture-and-word latent images in the film (4) will pass through the imaging aperture (231) and coincide to the shielding part on an appropriate position of the imaging aperture. Due to the fact that the shielding part is an opaque material, double exposed color images will occur on each photograph. Therefore, the imaging system for producing double exposure composite images describe in the present invention overcomes shortcomings in traditional art, such as limited applicability of ordinary cameras to films, limitation in application of discardable cameras, etc.; it solve the relationship between the exposed latent images on film and the film transmission and frame-fixing on the camera, simplifies installation and application of film to camera, enhance the adaptability of cartridge-clip cameras to different types of films, and helps to align pre-exposed picture-and-word information with the content photographed subsequently to compose complete pictures; in that way, it helps to decrease cost for consumers and enrich people's life.

Embodiment 2:

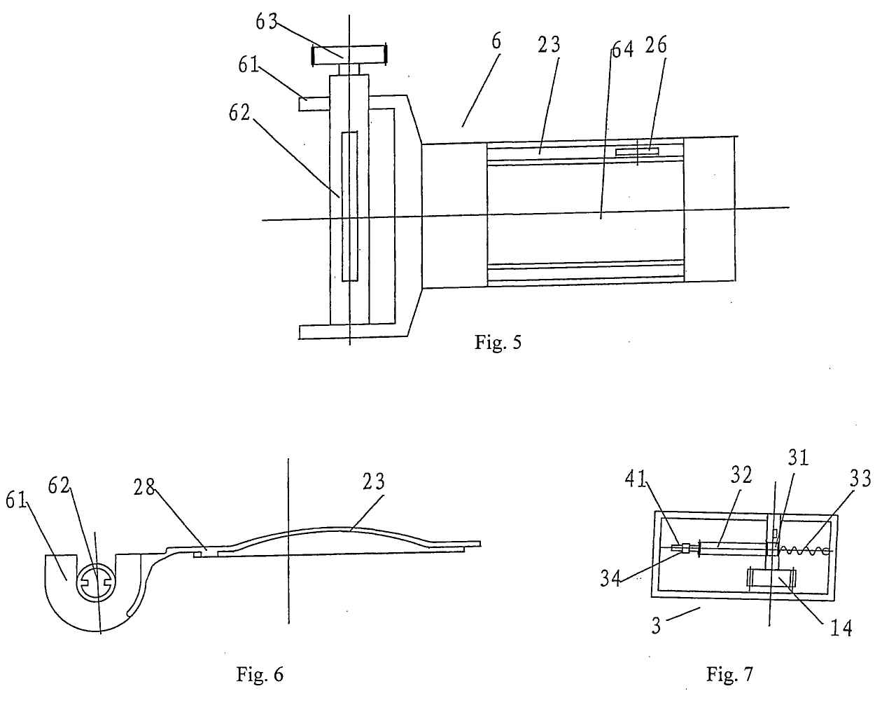

As shown in FIG. 5 and FIG. 6, said cartridge clip (21) may also have a clipping seat (6), which may comprise an imaging frame (23) and a bracket (61) on the left; a winding shaft (62) is hinged in said bracket (61) and is fitted with a spur gear (63) on its top; said imaging frame (23) has a standard imaging aperture (64), a through-hole (26) of fixed-frame wheel, and a positioning tab (28) on its back.

For a standard 135# film roll (without picture-and-word latent images), when the cartridge-clip (6) is loaded into the main body (1) of said cartridge-clip camera, the through-hole (26) of the fixed-frame wheel is hung to the first tooth of said fixed-frame wheel (14), which has reset to its original position; the spur gear (63) on the winding shaft (62) is coupled to the spur gear (17) in the groove of the camera; when the standard film roll is mounted in the right chamber (13) of the camera, full-frame photographing may be performed with the standard imaging aperture and ordinary photographs will be created. If the imaging frame on the clipping seat is a half-frame one, half-framing photographing may be performed, as shown in FIG. 11 and FIG. 11A, wherein FIG. 11A shows a clipping seat with a standard imaging frame; FIG. 11 shows a clipping seat with a half-frame imaging frame. Please see Embodiment 6 for the switching structure between them.

In that way, a cartridge-clip camera may use either a cartridge-clip film or a common film. Thus the applicability of cartridge-clip cameras is expanded to meet different requirements of people.

The rest application conditions and benefits of the present embodiment are similar to those of Embodiment 1 and will not be described further.

Embodiment 3

Said camera for producing double exposure composite images has a film groove on one side of its camera body, and a film with picture-and-word information/ordinary film may be inserted and mounted in the camera through said groove.

Embodiment 4

The film (4) in said cartridge-clip film roll (2) may be a film with picture-and-word information or an ordinary film. The casing of said cartridge-clip film roll (2) may indicate the picture-and-word information and the information position in said film to facilitate people to choose.

The application conditions and benefits of the present embodiment are similar to those of Embodiment 1 and will not be described further.

The imaging system for producing double exposure composite images described in the invention may serve as an information medium, in particular, the film for producing double exposure composite images described here may be mounted in a cartridge-clip, which may be reused in the cartridge-clip camera. Said film has two zones, an unexposed zone and an exposed zone. Said unexposed zone and exposed zone may be formed as follows: as an information medium for producing double exposure composite images, the film has latent images of great ceremonies, children cartoons, ad presentations, scenery of tourist spots, image design content, blessings, or propaganda for meetings or activities in its exposed zone. Said exposed zone may be at any position of any latent image, such as top, bottom, or any corner, or any border. Moreover, the latent images are combined with the image created in re-exposure to form innovate and unique photographs.

The film with double exposure composite images may be loaded into a cartridge clip to create a cartridge-clip film roll, which may be packed and sold independently and may also be used in such a distribution way, i.e., the film roll may contain ad picture-and-word information of different customers in its exposed zone, thus it may be distributed to customers freely as a gift.

Embodiment 5:

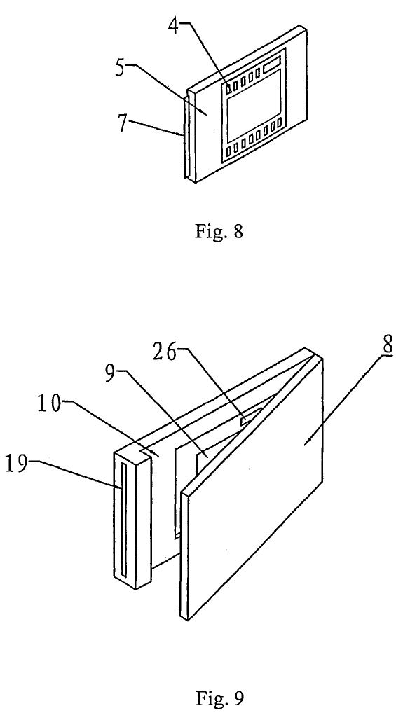

As shown in FIG. 8 and FIG. 9, the imaging system for producing double exposure composite images may be used with a single-sheet-film card, which comprises a card carrier (5), a film (4′), and a sealed shielding plate 7; the single-sheet-film clipping seat has a standard imaging frame (9), a positioning groove (10), a through-hole (26) of fixed-frame wheel, a hole (19) for drawing out the shielding plate, and a sealed rear cover (8); when packed in a casing, the single-sheet-film card can be sold independently as a commodity. If the single-sheet-film card is used with the cartridge-clip camera, it must be loaded into a dedicated clipping seat; then the clipping seat may be loaded into the cartridge-clip camera, and the imaging frame (9) on the front side of said dedicated clipping seat will coupled with the cartridge clip on the camera body. Then, photographing may be done when the sealed shielding plate (7) is drawn out from the drawing hole (19) for the shielding plate. The imaging effect of such a camera is the same as that of an ordinary camera.

Embodiment 6:

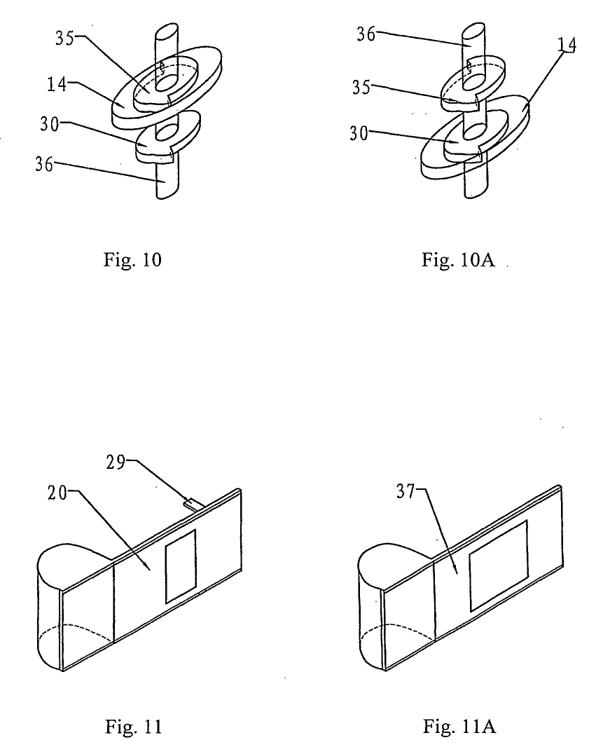

Please see FIGS. 10, 10A, 11, and 11A. The imaging system for producing double exposure composite images may utilize standard 135# film to achieve half-frame transmission. The half-frame transmission structure comprises ratchet wheels (30, 35) for fixed-frame wheel (14) on the camera body and switching pin (29) for the fixed-frame wheel (41) on the dedicated half-frame clipping seat (20); wherein when the full-frame clipping seat (37) is mounted, the ratchet wheel (30) is set to default and it locks the fixed-frame wheel when said wheel rotates 360° to achieve full-frame photographing, as shown in FIGS. 10A and 11A; when the dedicated half-frame clipping seat (20) is mounted, the switching pin (29) on it will prop the frame-fixing shaft (36) and drive the racket wheels (30, 35) to move downward simultaneously and alter the control state of camera body to the racket wheel (35), which fix the fixed-frame wheel whenever the fixed-frame wheel rotates 180° to achieve half-frame photographing, as shown in FIG. 10 and FIG. 11.

Embodiment 7:

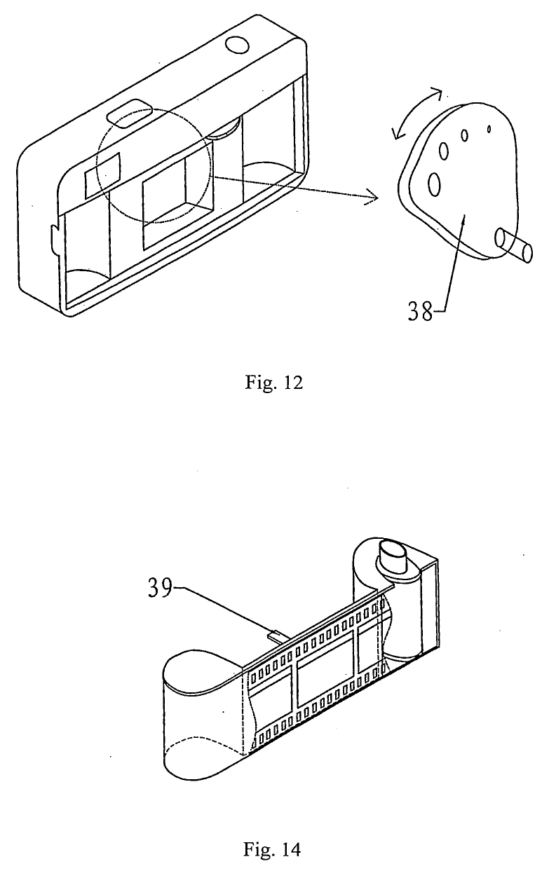

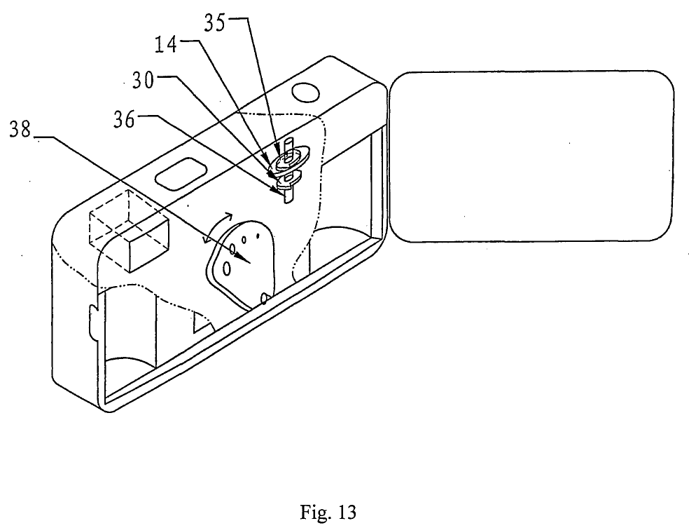

Please see FIG. 12, FIG. 13, and FIG. 14. The photosensitivity-adjusting mechanism of the cartridge-clip camera comprises an aperture adjusting plate (38) (with apertures of different diameters corresponding to films of specific photo-sensitivities) on the camera body, a photosensitivity-adjusting pin (39) on the dedicated cartridge clip. When the dedicated cartridge clip is loaded into the camera body along with a film of specific photosensitivity, the photosensitivity-adjusting pin (39) drives the aperture-adjusting plate (38) to rotate to match a specific aperture to the shutter aperture. In that way, a film of specific photosensitivity may achieve corresponding exposure amount.

An application feature of the invention is: The single-sheet-film cards may be sold directly as a commodity or distributed as a gift. In addition, the image composition function of those single-sheet-film cards enriches photographs, decreases the cost of them as gift or ad medium, and enhances the adaptability of cartridge-clip camera to films.

The second application feature of the invention is: The half-frame photographing function helps to save film space, and enrich the application of cartridge-clip camera and its dedicated cartridge clip.

The third application feature of the invention is: Equipped with a photosensitivity-adjusting mechanism, the cartridge-clip camera and its dedicated cartridge clip may use films of different photo-sensitivities, facilitating to expand the applicability of cartridge-clip camera and satisfy different requirements of customers.

What is claimed is:

1. A cartridge-clip camera for the image system for producing double exposure composite images, said camera comprises a camera body, a lens, and a counter, and:
a frame-fixing device, which may fix the start position of said film and regulate the breadth of film frame;
a cartridge clip, which may hold a film cassette; said frame-fixing device is mounted on said clipping seat;
an automatic resetting device connected to said frame-fixing device; when the film is attached to said frame-fixing device and the start position of it is determined, the position of the first frame of the film may be determined with the automatic resetting device; when the rear cover of the camera is opened, said automatic reset device will reset automatically to ensure the accurate alignment of the composite image after re-exposure.

2. The cartridge-clip camera as in claim 1, wherein said camera body has a rear cover; when said rear cover is opened, said film may be loaded into said cartridge clip.

3. The cartridge-clip camera as in claim 1 or 2, wherein said cartridge clip is connected to a left chamber and a right chamber on its sides, respectively; said right chamber has a winding hand-wheel and a spindle nose on the top; said left chamber has a spur gear embedded in a groove on the top; said cartridge clip has a frame-fixing device mounted on it.

4. The cartridge-clip camera as in claim 1 or 2, wherein said cartridge clip has a positioning groove on it.

5. The cartridge-clip camera as in claim 1 or 2, wherein said frame-fixing device may be a fixed-frame wheel, which may protrudes out from the right-top part of said cartridge clip.

6. The cartridge-clip camera as in claim 5, wherein said camera body has a 180° unidirectional frame-fixing ratchet wheel and an adjusting pin mounted with a clipping seat dedicated for half-frame transmission; said dedicated clipping seat is set to use with a half-frame imaging frame.

7. The cartridge-clip camera as in claim 6, wherein the 360° unidirectional frame-fixing ratchet wheel in said camera body is set as default, the original dedicated clipping seat is fixed on the cartridge clip in the chamber of said cartridge-clip camera, the film is transferred through said 360° unidirectional ratchet wheel, which locks the film at 35 mm interval in each rotation to implement full frame imaging; an additional 180° unidirectional frame-fixing ratchet is added and set to standby mode, when the clipping seat dedicated for half-frame transmission (with a half-frame imaging frame and an adjusting pin) is mounted on said camera, it alters the position of said frame-fixing ratchet wheel on said camera body, said clipping seat dedicated for half-frame transmission is also fixed on the cartridge clip in the chamber of said cartridge-clip camera, the film is transferred through said 180° unidirectional ratchet wheel, which locks the film at 16 mm interval in each cycle to implement half-frame imaging.

8. The cartridge-clip camera as in claim 1 or 2, wherein said camera body has a reciprocating aperture plate with pre-drilled apertures of different diameters; the clipping seat for different types of films has an adjusting pin, which will prod said aperture plate when the clipping seat is loaded into the cartridge clip in said cartridge-clip camera.

9. The cartridge-clip camera as in claim 8, wherein said camera body has a reciprocating aperture plate passing through the adjusting pin on different types of film clipping seats; there are apertures of different diameters on said reciprocating aperture plate, when said reciprocating aperture plate is mounted in the chamber of said cartridge-clip camera, said apertures will correspond to different photosensitivity settings, thus the cartridge-clip camera may be used wit films of different photo-sensitivities; through presetting the position of said adjusting pin, said cartridge-clip camera may distinguish photosensitivity of the film in a mechanical way.

10. The cartridge-clip camera as in claim 1 or 2, wherein said automatic resetting device comprises a gearing structure and an elastic resetting element.

11. The cartridge-clip camera as in claim 1, 2, or 4, wherein said automatic resetting device comprises a pair of coupled gear/rack; said gear is connected to said fixed-frame wheel in axial direction; said elastic resetting element may be a draught spring connected to said camera body on one end and to a end of said rack on the other end; said rack has a lock hole that may be coupled with the lock pin on said rear cover on the other end.

12. The cartridge-clip camera as in claim 1, 2, or 3, wherein said cartridge clip may contain a clipping seat.

13. The cartridge-clip camera as in claim 12, wherein said clipping seat may comprise an imaging frame and a bracket on the left; a winding shaft is hinged in said bracket and is fitted with a spur gear on its top; said imaging frame has a standard imaging aperture, a through-hole of fixed-frame wheel, and a positioning tab on its back.

14. The cartridge-clip camera as in claim 1, wherein said camera body has a film bank on one side.

15. A cartridge-clip camera for image system producing double exposure composite images, mainly comprising a single-sheet-film card and a suited clipping seat;
wherein said single-sheet-film card is fixed in said clipping seat, which substitutes the chamber originally used for above cartridge-clip film and has a imaging frame on its front; said clipping seat may be coupled with the cartridge clip of said camera body; when they are coupled to each other, the length of projection plane in the chamber of said clipping seat is still equal to the focal length of said camera.

16. The cartridge-clip camera for image system for producing double exposure composite images as in claim 15, wherein said single-sheet-film card comprises: a card carrier, a film, and a sealed shielding plate (for sheet films with pre-imposed picture-and-word information, an imaging frame may be applied); said sheet film is installed in the chamber of said card carrier; said card carrier has sliding grooves for said sealed shielding plate on its both end; there is a positioning tab corresponding to a film sprocket hole in the chamber of said card carrier; the photo-sensing membrane of said sheet film faces against said sealed shielding plate; said dedicated clipping seat contact firmly with the inner wall of said imaging frame when it is mounted in said camera; there are positioning holes for chamber of said dedicated clipping seat at the cross edges of said card carrier.

17. The cartridge-clip camera for image system for producing double exposure composite images as in claim 15 and 16, wherein said dedicated single-sheet-film clipping seat has an imaging frame on its front side, a positioning pin for installation of single-sheet-film cards in it, and a sealed shielding plate on its back; wherein said imaging frame on the front of said single-sheet-film clipping seat is coupled with the cartridge clip of said camera body.

18. The cartridge-clip camera for image system for producing double exposure composite images as in claim 15 and 16, wherein said film membrane of single-sheet-film card faces against said sealed shielding plate; when said single-sheet-film card is loaded in said dedicated clipping seat during said sealed shielding plate is in closed state, the positioning hole on said sheet film is coupled to the positioning pin on said dedicated clipping seat; when the sealed clipping seating plate of said dedicated clipping seat is closed and the sealed shielding plate is drawn out, the film contacts seamlessly with the imaging frame of said dedicated clipping seat, and said dedicated clipping seat in turn contacts seamlessly with the cartridge clip in said cartridge-clip camera; after the rear cover of said camera body is closed, photographing may be done to achieve common sheet films with images; then, the sheet film with pre-exposed information may be loaded into said single-sheet-film cards to create an information a single-sheet-film card, which then is added with said imaging frame; the photo-sensing membrane of said information single-sheet-film card faces against said sealed shielding plate, which is in closed state; when said single-sheet-film card is loaded into the chamber of said dedicated clipping seat, the positioning hole of said single-sheet-film card is coupled with the positioning pin in said dedicated clipping seat; when the rear plate of said dedicated clipping seat is closed, the sealed shielding plate for said single-sheet-film card may be drawn out, and then said imaging frame contacts closely with the inner wall of said dedicate clipping seat, and said dedicate clipping seat is coupled with the cartridge clip in the chamber of said cartridge-clip camera; when the rear cover of said cartridge-clip camera is closed, photographing may be done for re-exposure in order to create composite images on said single-sheet-film cards.

19. A kind of cartridge-clip film roll for imaging system for producing double exposure composite images, wherein said cartridge-clip film roll comprises a cartridge clip, a cassette, a roll of film, and a casing.

20. The cartridge-clip film roll as in claim 19, wherein said cartridge clip has an imaging frame and a cassette bracket on its right side; said cassette bracket supports a cassette and a dark chamber on the left; said imaging frame has an imaging aperture, a through-hole of fixed-frame wheel, a film lock pin, and a positioning tab on its back.

21. The cartridge-clip film roll as in claim 19, wherein said imaging aperture may has a shielding part at an appropriate position.

22. The cartridge-clip film roll as in claim 19, wherein the film in said cartridge-clip film roll may be a film with picture-and-word information or an ordinary film.

23. The cartridge-clip film roll as in claim 19, wherein the casing of said cartridge-clip film roll may indicate the picture-and-word information and the information position of said film.

24. A positioning method for cartridge-clip film roll of the imaging system for producing double exposure composite images, wherein said positioning method comprises the following procedures:
a. form unique installation sprocket hole on said film with picture-and-word information;
b. load said film in the cassette and place the cassette in the cassette bracket on said cartridge clip to form a cartridge-clip film roll;
c. load said cartridge-clip film roll in a suited cartridge-clip camera.

25. The positioning method for said cartridge-clip film roll as in claim 24, wherein said procedure “a” and procedure “b” mean: coincide unique installation sprocket hole on said film to the through-hole of fixed-frame wheel on the cartridge clip.

26. The positioning method for said cartridge-clip film roll as in claim 24, wherein said procedure “b” means: the picture-and-word latent image on each frame of said film faces against the imaging aperture on said cartridge clip and coincide to the shielding part of said imaging aperture.

27. The positioning method for said cartridge-clip film roll as in claim 24, wherein said procedure “c” means: when the cartridge-clip film roll is loaded into the cartridge-clip camera, the unique installation sprocket hole on said film and the through-hole of the fixed-frame wheel are hung together to the first tooth of said fixed-frame wheel, which has reset to its original position; when the rear cover of the camera is closed and the film is wound manually, each frame of picture-and-word latent image on said film will coincide to the lens of the camera; when the film is transferred, the rack of said automatic resetting device moves under the drive of said fixed-frame wheel and disengages from the gear, and then the lock pin on the rear cover will wedge into the lock hole on one side of said rack.

28. An application method for imaging systems for producing double exposure composite images, wherein the film of said cartridge-clip film roll has two zones: an unexposed zone and a exposed zone carrying picture-and-word information.

29. The application method as in claim 28, wherein the picture-and-word information in said exposed zone may be images of great ceremonies.

30. The application method as in claim 28, wherein the picture-and-word information in said exposed zone may be images of cartoons of children.

31. The application method as in claim 28, wherein the picture-and-word information in said exposed zone may be ad presentations.

32. The application method as in claim 28, wherein the picture-and-word information in said exposed zone may be scenery images of tourist spots.

33. The application method as in claim 28, wherein the picture-and-word information in said exposed zone may be image-planning content.

34. The application method as in claim 28, wherein the picture-and-word information in said exposed zone may be blessings or graphical images.

35. The application method as in claim 28, wherein the said exposed zone may be at any position in the frames of latent images and be composite with images created in re-exposure.

36. The application method as in claim 28, wherein said exposed zone contains ad picture-and-word latent images of different customers.

37. The application method as in claim 36, wherein said cartridge-clip film rolls may be sold independently.

38. The application method as in claim 36, wherein said cartridge-clip film roll may be freely distributed to consumers as a gift for sales promotion.
